(19) United States
(12) Patent Application Publication
(10) Pub. No.: US 2026/0081471 A1
(43) Pub. Date: Mar. 19, 2026

(54) WIRELESS CHARGER DEVICE SUPPORTING MULTIPLE WIRELESS POWER TRANSFER SPECIFICATIONS

(71) Applicant: Apple Inc., Cupertino, CA (US)

(72) Inventors: Grant S. Haug, Mountain View, CA (US); Srinivasa V. Thirumalai Ananthan Pillai, Santa Clara, CA (US); Ruiyang Lin, Milpitas, CA (US)

(73) Assignee: Apple Inc., Cupertino, CA (US)

(21) Appl. No.: 18/888,731

(22) Filed: Sep. 18, 2024

(51) Int. Cl. H02J 50/10; H01F 27/36; H02J 7/00; H02J 50/00; H02J 50/40; H02J 50/70; H02J 50/90

(52) U.S. Cl. CPC H02J 50/10; H02J 7/975; H02J 50/005; H02J 50/402; H02J 50/70; H02J 50/90; H01F 27/363; H01F 27/366

(57) ABSTRACT

A wireless charger device can support multiple different receiver devices having different wireless charging specifications. The wireless charger device can house two wireless power transmitter coils having different dimensions and arranged coaxially with each other. A first coil can have a size and shape compatible with a portable device such as a smart phone while the second coil can have a size and shape compatible with a smaller device such as a smart watch. The first coil and the second coil can deliver power through the same charging surface, or the first coil can deliver power through a first charging surface while the second coil can deliver power through a second charging surface opposite the first charging surface.

BACKGROUND

This disclosure relates generally to wireless charging systems and in particular to wireless charger devices that can support multiple wireless power transfer specifications.

Portable electronic devices (e.g., mobile phones, media players, electronic watches, and the like) operate when there is charge stored in their batteries. Some portable electronic devices include a rechargeable battery that can be recharged by coupling the portable electronic device to a power source through a physical connection, such as through a charging cable. Using a charging cable to charge a battery in a portable electronic device, however, requires the portable electronic device to be physically tethered to a power outlet. Additionally, using a charging cable requires the portable electronic device to have a connector, typically a receptacle connector, that is configured to mate with a connector, typically a plug connector, of the charging cable. The receptacle connector includes a cavity in the portable electronic device that provides an avenue via which dust and moisture can intrude and damage the device. Further, a user of the portable electronic device has to physically connect the charging cable to the receptacle connector in order to charge the battery.

To avoid such shortcomings, wireless charging technologies (also referred to as inductive charging technologies) have been developed that exploit electromagnetic induction to charge portable electronic devices without the need for connectors. For example, some portable electronic devices can be recharged by merely resting the device on a charging surface of a wireless charger device. A transmitter coil disposed below the charging surface is driven with an alternating current that produces a time-varying magnetic flux that induces a current in a corresponding receiver coil in the portable electronic device. The induced current can be used by the portable electronic device to charge its internal battery.

### SUMMARY

For efficient wireless power transfer, it is desirable for the transmitter and receiver coils to have matching characteristics, including physical dimensions and/or resonant frequencies. Despite ongoing efforts to standardize wireless power transfer components and protocols, a single form factor for wireless chargers remains elusive, in part due to the wide variety of form factors of power-receiving devices. For instance, larger coils generally support higher rates of power transfer and are preferred for smart phones and other high-power devices. However, wearable devices such as watches, rings, earbuds, or the like generally have smaller form factors that limit the size of an inductive charging coil that can be incorporated into the device, often to a size that may not provide adequate charging capability for larger and/or higher-power devices such as smart phones. Consequently, a user with multiple devices of different types may require multiple wireless charger devices having different form factors to charge the devices. Managing multiple different charger devices is widely viewed as an inconvenience. Accordingly, reducing the number of different wireless charger devices that a user may need is desirable.

Certain embodiments described herein relate to wireless charger devices that can support multiple different receiver devices having different wireless charging specifications. For example, the wireless charger device can have a housing shaped as a puck. The puck can house two wireless power transmitter coils (also referred to as inductive coils) having different dimensions and arranged coaxially with each other. A first inductive coil can have a size and shape compatible with a portable device such as a smart phone while the second inductive coil can have a size and shape compatible with a smaller device such as a smart watch. In some embodiments, the dimensions of the two coils can be such that the second inductive coil fits inside an inner diameter of the first inductive coil. To support magnetic alignment of the induction coils with receiver coils in different devices, the wireless charger device can include multiple magnetic alignment components. For instance, a central magnet for alignment of devices that use the second inductive coil can be positioned inside the inner diameter of the second inductive coil, and an annular magnetic alignment component for alignment of devices that use the first inductive coil can be positioned around the outer perimeter of the first transmitter coil. In some embodiments, the wireless charger device can have a single charging surface (e.g., on one circular side of the puck), and both inductive coils can transmit power (at different times) through the single charging surface, allowing two types of devices to be charged at different times using the same wireless charger device. In other embodiments, the wireless charger device can have two opposing charging surfaces (e.g., on both circular sides of the puck), with the first inductive coil transmitting power through one charging surface while the second inductive coil transmits power through the opposing charging surface. Where two charging surfaces are provided, both inductive coils can be operated concurrently to charge different devices at the same time.

The following detailed description, together with the accompanying drawings, will provide a better understanding of the nature and advantages of the claimed invention.

### BRIEF DESCRIPTION OF THE DRAWINGS

FIGS. 1A and 1B show a rear perspective view and a front perspective view of a wireless charger device according to some embodiments.

FIG. 2 shows a simplified exploded view of a wireless charger device according to some embodiments.

FIG. 3 shows a simplified cross-section view of a wireless charger device according to some embodiments.

FIGS. 4A and 4B show simplified partial cross-section views of a wireless charger device according to some embodiments.

FIGS. 5A and 5B illustrate a magnetic polarization pattern for an alignment magnet in a wireless charger device according to some embodiments: FIG. 5A shows a simplified partial cross-section view of a wireless charger device having a central alignment magnet, and FIG. 5B shows a top view of the central magnet, further illustrating the magnetic flux.

FIG. 6 shows a simplified schematic diagram of control and driver circuitry for a wireless charger device according to some embodiments.

FIGS. 7A and 7B show a top perspective view and a bottom perspective view of a wireless charger device according to some embodiments.

FIG. 7C shows a simplified side view of a stacked arrangement for concurrent wireless charging of multiple devices using a wireless charger device of the kind shown in FIGS. 7A and 7B according to some embodiments.

FIG. 8 shows a simplified exploded view of a wireless charger device according to some embodiments.

FIG. 9 shows a simplified cross-section view of a wireless charger device according to some embodiments.

FIG. 10 shows a simplified schematic diagram of control and driver circuitry for a wireless charger device according to some embodiments.

### DETAILED DESCRIPTION

The following description of exemplary embodiments of the invention is presented for the purpose of illustration and description. It is not intended to be exhaustive or to limit the claimed invention to the precise form described, and persons skilled in the art will appreciate that many modifications and variations are possible. The embodiments have been chosen and described in order to best explain the principles of the invention and its practical applications to thereby enable others skilled in the art to best make and use the invention in various embodiments and with various modifications as are suited to the particular use contemplated.

Certain embodiments described herein relate to wireless charger devices that can support different wireless power receiver devices having receiver coils confirming to different wireless charging specifications. For convenience of description, the terms “L-type” and “S-type” are used herein to distinguish two wireless charging specifications. It is assumed that L-type devices use inductive coils having larger diameter and can charge at a higher maximum power than S-type devices. In some embodiments, L-type devices may correspond to devices that users would typically carry with them (e.g., a smart phone that can be carried in a hand or pocket or bag), while S-type devices may correspond to smaller devices that users would typically wear on their person (e.g., a watch or other jewelry item, smart eyeglasses, headphones, earbuds or the like); however, embodiments are not restricted to any particular device types or combination of device types.

### Example Single-Sided Wireless Charger Devices

In some embodiments, a “single-sided” wireless charger device provides a single charging surface that accommodates both L-type and S-type devices.

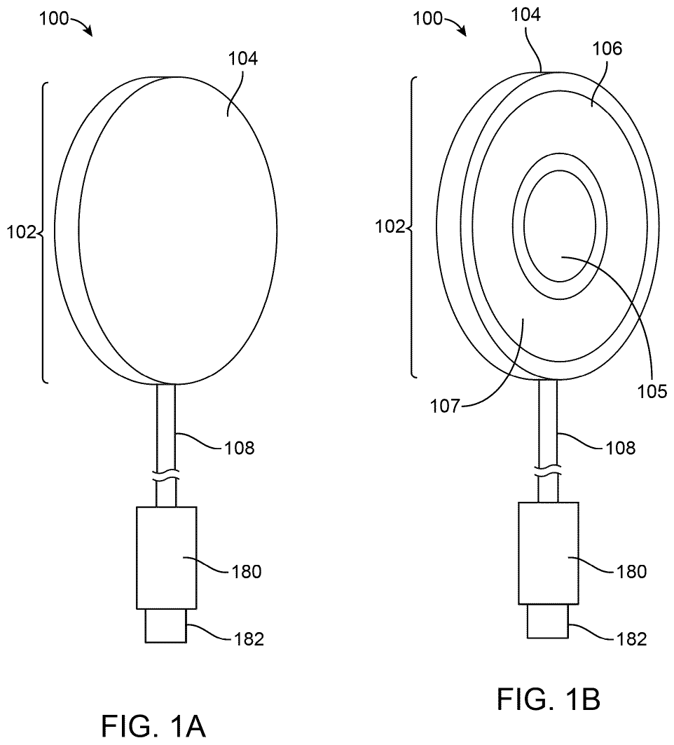

FIGS. 1A and 1B show a rear perspective view and a front perspective view of a single-sided wireless charger device 100 according to some embodiments. Wireless charger device 100 can include a puck-shaped main body 102 formed from an enclosure 104 and a cap 106. Cap 106 can include a central portion 105 and an annular outer portion 107. A cable 108 can extend from the side of enclosure 104. The distal end of cable 108 (which can be of arbitrary length) can include a connector boot 180 that provides a connector, such as a USB-C plug connector 182, to allow cable 108 to be connected to an external power source (e.g., wall power via a USB-compatible power adapter capable of receiving USB-C plug connector 182). Enclosure 104 can be made of aluminum, other electrically conductive materials, or a plastic material with a conductive insert and can hold a large inductive transmitter coil (compatible with a first, or L-type, wireless charging specification) and a small inductive transmitter coil (compatible with a second, or S-type, wireless charging specification). The large and small inductive transmitter coils can be annular coils having respective inner diameters and respective outer diameters, related such that the inner diameter of the large coil is greater than the outer diameter of the small coil. In some embodiments, the inner and outer diameters of the small coil can correspond to a wireless charging specification associated with S-type devices while the outer diameter of the large coil corresponds to a (different) wireless charging specification associated with L-type devices. In some embodiments, the inner diameter of the large coil may be increased from a nominal L-type specification to accommodate the small coil. (This may somewhat reduce charging performance for L-type devices; however, this may be an acceptable tradeoff for the convenience of having a single wireless charging device rather than two separate wireless charging devices.) The two transmitter coils can be arranged coaxially and oriented to direct magnetic flux toward cap 106.

Cap 106 can provide charging surfaces for two types of receiver devices: S-type devices having a receiver coil whose outer diameter corresponds to the outer diameter of the small transmitter coil; and L-type devices having a receiver coil whose outer diameter corresponds to the outer diameter of the large transmitter coil. For instance, central portion 105 and outer portion 107 of cap 106 can both be made of polycarbonate or other plastic and coated on the front side (the surface visible in FIG. 1B) with soft-touch silicone or the like to provide a durable surface. Other materials that are permeable to electromagnetic fields can also be used. In some embodiments, the exposed surfaces of central portion 105 and outer portion 107 of cap 106 can be low-friction surfaces (e.g., textured silicone), as wireless charger device 100 can rely on magnetic forces rather than friction for maintaining alignment with a device to be charged. In some embodiments, central portion 105 of cap 106 can provide a concave surface (e.g., for charging a wearable device that has a convex charging surface) while outer portion 107 of cap 106 can provide a flat surface (e.g., for charging a phone that has a flat charging surface). Central portion 105 and outer portion 107 of cap 106 can be formed as a single structure or as separate structures, with outer portion 107 being an annular structure that has a central opening through which central portion 105 is exposed. In some embodiments, the exposed area of central portion 105 has a diameter larger than the outer diameter of the small inductive coil and smaller than the inner diameter of the large inductive coil.

In operation, a device to be charged can be placed in contact with cap 106. The device to be charged can be either an L-type device or an S-type device. Control logic in wireless charger device 100 can determine the type of receiver coil that is present (e.g., L-type or S-type) and provide power to the appropriate one of the large or small transmitter coils.

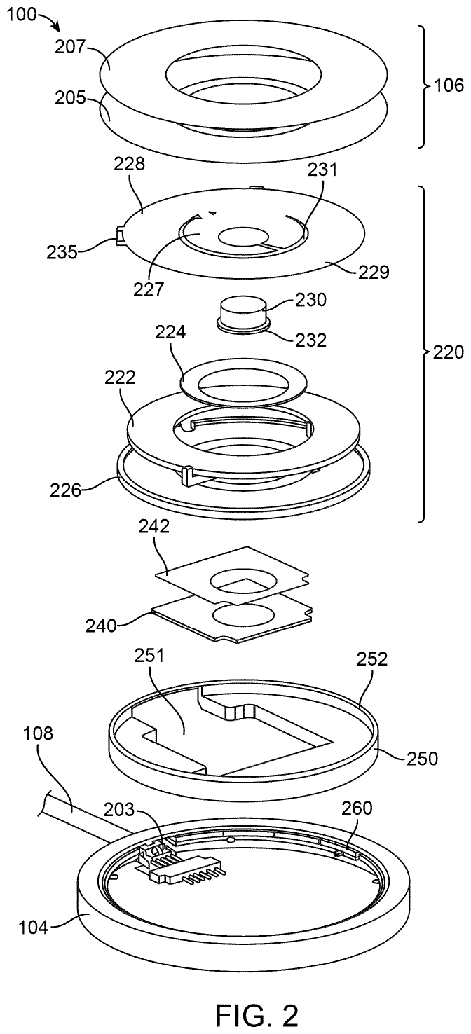

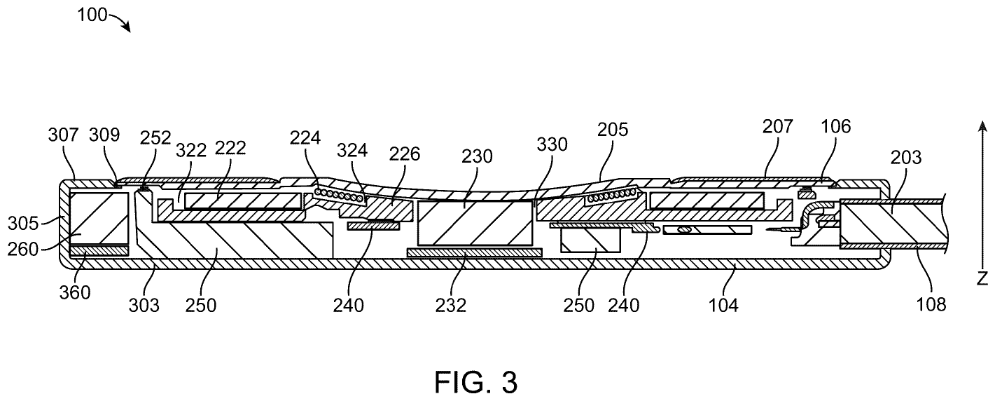

FIG. 2 shows a simplified exploded view of wireless charger device 100 according to some embodiments, and FIG. 3 shows a simplified side cross-section view of wireless charger device 100 according to some embodiments. As described above, wireless charger device 100 can have a puck-shaped main body defined by a cap 106 and an enclosure 104. For convenience of description, the term “front” is used herein to refer to the side of wireless charger device 100 having cap 106, while the term “back”(or “rear”) is used herein to refer the opposing side.

In this example, cap 106 is a two-piece structure that includes an inner cap 205 and an outer cap 207. Both of inner cap 205 and outer cap 207 can be made of soft-touch silicone or other materials as described above. Inner cap 205 can provide structural rigidity while outer cap 207 can be a thinner overlay. As shown, outer cap 207 can be an annular structure, with a portion of inner cap 205 being exposed through the central opening of outer cap 207. Inner cap 205 can have a concave central region as best seen in FIG. 3. In some embodiments, inner cap 205 and outer cap 207 can have different colors for an esthetic effect.

Enclosure 104 can be made of aluminum, other electrically conductive materials, or a plastic material. As best seen in FIG. 3, enclosure 104 can be formed as a monolithic structure that includes a rear wall 303, a sidewall 305, and an overhanging lip 307 at the front surface of wireless charger device 100. In some embodiments, lip 307 can be sloped (e.g., at an angle of around 5 or 10 degrees) so that its inner edge is higher than its outer edge. A recessed ledge 309 can extend radially inward from lip 307 to receive cap 106. An annular magnetic alignment component 260 for use in aligning L-type devices can be positioned adjacent to sidewall 305 of enclosure 104, extending between rear wall 303 and lip 307. Annular magnetic alignment component 260 can be formed of arcuate magnets (e.g., sintered rare-earth magnets) that are magnetized into a “quad-pole” configuration in which an inner arcuate region of each magnet has an axial magnetization in a first direction, an outer arcuate region of each magnet has an axial magnetization in a second direction opposite the first direction, and a central arcuate region of each magnet is non-magnetized. A DC magnetic shield 360 can be placed behind annular magnetic alignment component 260. Annular magnetic alignment component 260 can direct magnetic flux through lip 307, providing a magnetic force to align a compatible device to the top surface of wireless charger device 100. In some embodiments, L-type devices can conform to specifications of the Magnetic Power Profile defined in the Qi v2.0 standard promulgated by the Wireless Power Consortium (referred to herein as “MPP specifications”), and annular magnetic alignment component 260 can conform to MPP specifications.

As shown in FIG. 2, a charging coil assembly 220 can include a large inductive coil 222, a small inductive coil 224, a ferrite 226, an electric shield 228, and a central magnet 230. Each of large inductive coil 222 and small inductive coil 224 can be a coil of wound copper wire. Large inductive coil 222 and small inductive coil 224 can be arranged coaxially; the common axis of large inductive coil 222 and small inductive coil 224 is sometimes referred to herein as the “z-axis. ” As best seen in FIG. 3, large inductive coil 222 can be a flat planar coil, while small inductive coil 224 can be contoured to approximate the concave shape of inner cap 205. In this example, the inner diameter of large inductive coil 222 is larger than the outer diameter of small induction coil 224, which can help to avoid interference between the two coils during operation. Ferrite 226 can be made of ferrimagnetic material (e.g., MnZn). In some embodiments, ferrite 226 can be made of a single integral piece of the ferrimagnetic material that is shaped to serve as a flux guide for both large inductive coil 222 and small inductive coil 224. For instance, as shown in FIG. 3, ferrite 226 can have an outer annular recess region 322 to accommodate large inductive coil 222 and an inner annular recess region 324 to accommodate small inductive coil 224. Ferrite 226 can also extend over a main logic board 240 to shield main logic board 240 from AC electromagnetic fields generated by large inductive coil 222 or small inductive coil 224. Although not shown in detail, ferrite 226 can also include slits or grooves to accommodate electrical connections between main logic board 240 and large inductive coil 222 and small inductive coil 224.

Ferrite 226 can have a central opening 330 (shown in FIG. 3) to accommodate a central alignment magnet 230 for use with S-type devices. Central alignment magnet 230 can be a permanent magnet (e.g., sintered rare-earth magnet) having magnetic polarization along the z-axis. A DC magnetic shield 232 can be placed behind central alignment magnet 230. In some embodiments, central alignment magnet 230 can be used to align an S-type device that is to be charged using small inductive coil 224.

As shown in FIG. 2, electric shield (or “e-shield”) 228 can be positioned over the front surface of large inductive coil 222 and small inductive coil 224. E-shield 228 can be made of a flexible printed circuit board patterned with conductive material on the front side (the side oriented away from the inductive coils) to block AC electric fields while being transparent to (or having negligible effect on) AC magnetic fields. E-shield 228 can include an inner annular section 227 and an outer annular section 229 that are separated by a gap 231 and electrically coupled via a radial bridge 233. The patterns of conductive material in inner annular section 227 and outer annular section 229 can be similar or different from each other. For instance, inner annular section 227 can include radial conductive traces in a spoke-like pattern while outer annular section 229 can include arcuate conductive traces. As long as no trace forms a circle, eddy currents in e-shield 228 can be avoided. E-shield 228 can include one or more peripheral grounding tabs 235, which can extend around ferrite 226. Grounding tab 235 can be an extension of the flexible printed circuit board with one or more conductive traces printed thereon. The back surface of ferrite 226 can be completely or partially coated or covered by conductive material to provide grounding, and grounding tab 235 can be electrically connected to the conductive material on the back surface of ferrite 226.

A support frame 250 can be positioned between annular magnetic alignment component 260 and charging coil assembly 220, to provide space to accommodate main logic board 240. Support frame 250 can be a frame made of glass-reinforced polycarbonate or other plastics or the like and can have a raised outer periphery that extends toward cap 106. The center portion of support frame 250 can include an opening 251 to accommodate main logic board 240 without adding to the overall height of wireless charger device 100. A near-field communication (NFC) coil 252, which can be, e.g., a planar coil of three, four, or five turns, can be placed on top of the raised outer periphery of support frame 250 and held in place using pressure-sensitive adhesive (PSA). As shown in FIG. 3, NFC coil 252 can be inboard of the inner edge of lip 307 and can transmit through cap 106. Ends of NFC coil 252 can be electrically coupled to main logic board 240, and main logic board 240 can include NFC tag circuitry that can support identification and/or authentication of wireless charger device 100 to a compatible electronic device. In some embodiments, NFC coil 252 may be used with L-type devices that charge via large inductive coil 222 and that incorporate compatible NFC reader circuitry.

Main logic board 240 can secured to the back surface of ferrite 226 using a PSA 242. Although not shown in detail, main logic board 240 can include contact pads that connect to external wires (e.g., from cable 108) extending through opening 203 of enclosure 104, contact pads that connect to the ends of large inductive coil 222 and small inductive coil 224, and additional ground contacts on the back side (bottom side in FIGS. 2 and 3) for grounding enclosure 104. Main logic board 240 can also include circuit components to control operation of large inductive coil 222 and small inductive coil 224. Such components can include, e.g., surface-mounted integrated circuits that are mounted on the back side of main logic board 240 and extend into opening 251 of support frame 250. For example, depending on implementation, main logic board 240 can be coupled to receive DC power from cable 108 and can include power converter circuitry (e.g., a boost circuit and an inverter) to produce AC current to drive large inductive coil 222 or small inductive coil 224. In some embodiments, some or all of the power converter circuitry can be external to the main body formed by enclosure 104 and cap 106. For instance, some or all of the power converter circuitry can be disposed in connector boot 180 at the distal end of cable 108, and main logic board 240 can receive AC power via cable 108. In addition or instead, main logic board 240 can include logic circuits (e.g., a microcontroller, ASIC, FPGA, or the like) to monitor the behavior of large inductive coil 222 and small inductive coil 224 and to control current supplied to large inductive coil 222 and small inductive coil 224 based on the monitoring. Specific examples of control and driver circuitry for wireless charger device 100 are described below. In some embodiments, main logic board 240 can also include NFC tag circuit components coupled to NFC coil 252. In various embodiments, logic circuits, power circuits, and/or NFC tag circuits can be implemented as integrated circuits mounted on main logic board 240, and the integrated circuits may be covered by shield cans to avoid electrical interference.

As shown in FIGS. 2 and 3, cable 108 can enter enclosure 104 via an opening 203 through sidewall 305 of enclosure 104. Cable 108 can include multiple wires that connect to contacts on the underside of main logic board 240. The wires can include AC and/or DC power wires for one or for one or both of large inductive coil 222 and/or small inductive coil 224, as well as signal wires to enable data communication between main logic board 240 and circuitry disposed elsewhere in cable 108 (e.g., in cable boot 180).

In operation, a device to be charged (e.g., a portable or wearable device) can be placed on the charging surface defined by cap 106. The device can be either L-type (having an inductive receiver coil compatible with large inductive coil 222) or S-type (having an inductive receiver coil compatible with small inductive coil 224). Presence and type of device can be determined, e.g., using low-power pings or the like. In a low-power ping, a small AC current can be passed through large inductive coil 222, and a particular change in impedance can be detected when a compatible L-type device is present. Similarly, a small AC current can be passed through small inductive coil 224, and a particular change in impedance can be detected when a compatible S-type device is present. Wireless charger device 100 can be configured such that low-power pings are alternately performed using large inductive coil 222 and small inductive coil 224 (so that only one coil at a time is active). When a device is detected responsive to a low-power ping, the corresponding inductive coil can be activated to begin charging and/or to communicate with the detected device using modulation of the current (e.g., to receive a request for power, to determine a power level to provide, etc.). Low-power pings and charging operations can conform to Qi specifications or other specifications for wireless power transfer; any specification or combination of specifications can be used, and different specifications can be implemented for charging of L-type and S-type devices. For instance, large inductive coil 222 and small inductive coil 224 can operate at different frequencies and/or different levels of power output. It should also be understood that in this embodiment, large inductive coil 222 and small inductive coil 224 operate at different times to charge different devices, with the operation at any given time being determined based on whether a device is present and if so, the type of device that is present.

Although large inductive coil 222 and small inductive coil 224 do not operate at the same time, alignment magnets for both systems are present and may affect charging performance. For instance, DC magnetic flux from central alignment magnet 230 may enter an L-type receiving device that is placed on the charging surface and may adversely affect receiver coil performance. In some embodiments, such adverse effects can be reduced by making the central alignment magnet movable along the z-axis between an “active” position in which the central alignment magnet is proximate to cap 106 and an “inactive” position in which the central alignment magnet is proximate to rear wall 303 of enclosure 104. The central alignment magnet can be biased toward the inactive position; the bias can be overcome when a complementary magnet is in proximity to the central region of cap 106.

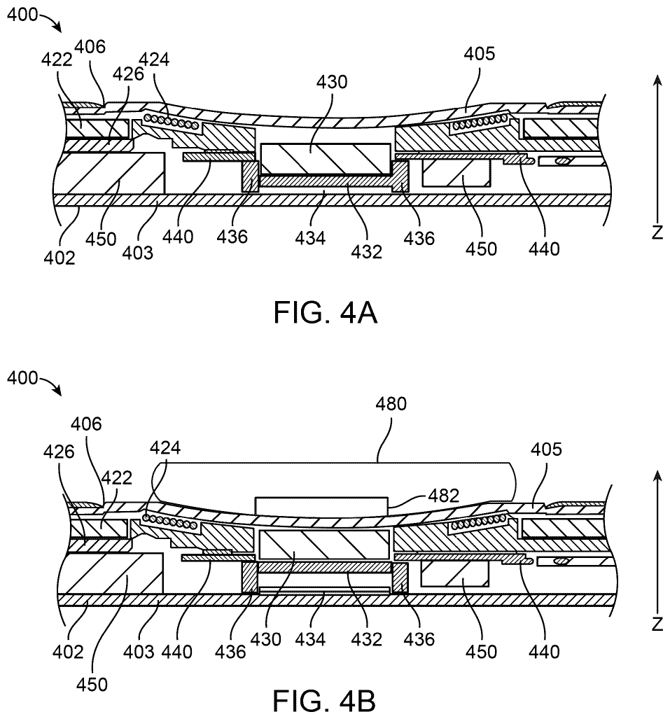

FIGS. 4A and 4B show simplified partial cross-section views of a wireless charger device 400 according to some embodiments. Wireless charger device 400 includes a movable central magnet 430. In other respects, wireless charger device 400 can be similar or identical to wireless charger device 100 described above. For example, cap 406, enclosure 402, large inductive coil 422, small inductive coil 424, ferrite 426, and main logic board 440 can be similar or identical to corresponding components described above.

Central magnet 430 can be a permanent magnet (e.g., sintered rare-earth magnet) having magnetic polarization along the z-axis, similar to central magnet 230. Optionally, a DC magnetic shield 432 can be attached to the back surface of center alignment magnet 430. In this example, central magnet 430 has a height (in the z-direction) that is shorter than the distance between rear housing 403 and the center of cap 406 (at indented portion 405). A return plate 434 can be attached to the inner surface of rear wall 403 of enclosure 402, behind central magnet 430. Return plate 434 can be made of a material that magnetically attracts central magnet 430. To define an axial travel path for central magnet 430, sidewalls 436 can be mounted on main logic board 440 as shown, e.g., using surface mount technology. In various embodiments, sidewalls 436 can be made of magnetic steel or ferritic material that provides confinement of magnetic flux from central magnet 430. Sidewalls 436 can form an annular structure or arcuate segments of an annular structure.

FIG. 4A shows central magnet 430 in the inactive position. Magnetic attraction between central magnet 430 and return plate 434 holds central magnet 430 away from the inner surface of cap 406. If a device that does not have a central alignment magnet (e.g., an L-type device) is placed on the charging surface formed by cap 406, central magnet 430 remains held in the inactive position during charging of the device. Provided that central magnet 430 in the inactive position is far enough below the inner surface of cap 406, the effect of central magnet 430 on charging performance for the L-type device can be reduced or minimized.

In FIG. 4B, an S-type device 480 is placed on the surface of cap 406. Device 480 charges using power from small inductive coil 424. As shown, device 480 includes an alignment magnet 482, which can be a permanent magnet having magnetic polarization along the z-axis in the same direction as central magnet 430. The magnetic attraction of alignment magnet 482 can overcome the attraction between central magnet 430 and return plate 434, and central magnet 430 can move into the active position. The magnetic force between central magnet 430 and alignment magnet 482 can hold device 480 in alignment during charging. In some embodiments, small inductive coil 424 and ferrite 426 can be designed such that central magnet 430 has acceptably small effect on power transfer efficiency for S-type devices.

In examples described above, the central alignment magnet can be a dipole magnet with magnetic orientation parallel to the z-axis. In other embodiments, the central alignment magnet can be a multi-pole magnet that confines most of the DC magnetic flux within the body of the central alignment magnet, reducing interference with the large inductive coil.

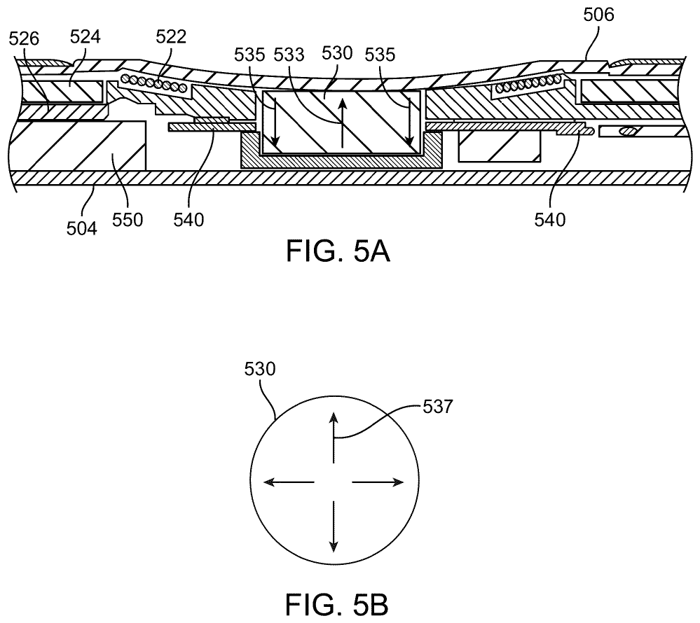

FIG. 5A shows a simplified partial cross-section view of a wireless charger device 500 according to some embodiments. Wireless charger device 500 includes a multi-pole central magnet 530. In other respects, wireless charger device 500 can be similar or identical to wireless charger device 100 described above. For example, cap 506, enclosure 502, large inductive coil 522, small inductive coil 524, ferrite 526, and main logic board 540 can be similar or identical to corresponding components described above.

As shown in FIG. 5A, central magnet 530 can be a multi-pole magnet that has a central region with magnetic polarity oriented in the +z direction (shown by arrow 533) and an outer annular region with magnetic polarity oriented in the −z direction (shown by arrows 535). An intermediate annular region between the central and outer regions can have little or no net magnetization.

FIG. 5B shows a top view of central magnet 530, further illustrating that magnetic flux at the top surface (represented by arrows 537) flows laterally from the center toward the outer perimeter of central magnet 530. Relative to a dipole magnet, the multi-pole configuration can reduce DC flux through cap 506 that may reach an L-type receiver device. Where an S-type device has a central alignment magnet with the same multi-pole polarization, magnetic attraction between central magnet 530 and the S-type device can be used for alignment.

In the example shown in FIGS. 5A and 5B, central magnet 530 can be in a fixed position; however, if desired, a movable multi-pole magnet can be implemented.

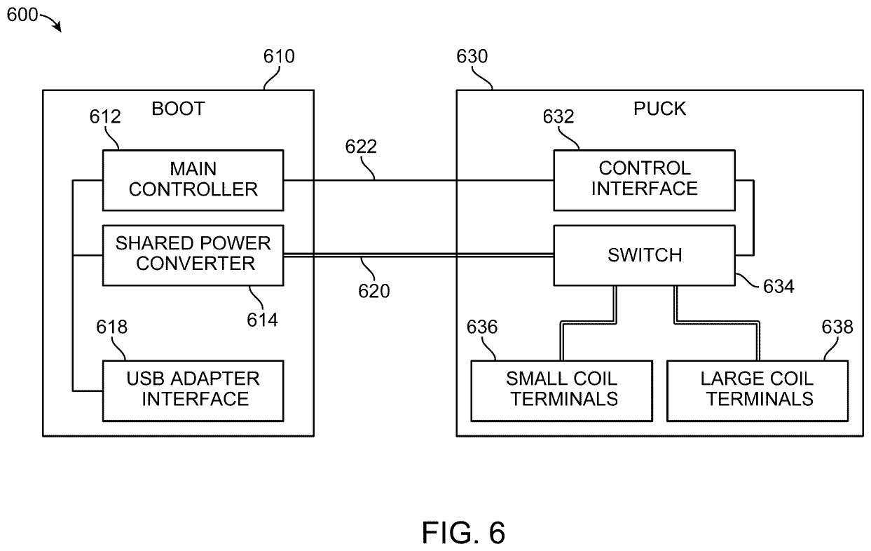

As described above, in wireless charger device 100 or similar devices, the large inductive coil and the small inductive coil are operated at different times. In some embodiments, control and driver circuitry for the two inductive coils can be shared to reduce costs. FIG. 6 shows a simplified schematic diagram of control and driver circuitry 600 for a wireless charger device according to some embodiments. Control and driver circuitry 600 can be implemented in wireless charger device 100 or similar devices where the inductive coils operate at different times. Control and driver circuitry 600 can include boot circuitry 610 and puck circuitry 630. In some embodiments, boot circuitry 610 can be included in a boot (e.g., connector boot 180) or other structure external to the puck-shaped housing of wireless charger device 100, while puck circuitry 630 can be included within the puck-shaped housing, e.g., using components mounted on main logic board 240 as described above.

Boot circuitry 610 can include a USB adapter interface 618, a main controller 612, and a (shared) power converter 614. USB adapter interface 618 can include a standard USB connector (e.g., USB-C plug connector 182 shown in FIGS. 1A and 1B) that can provide USB power and data signal paths. USB adapter interface 618 can provide the USB power (which is DC power) to power converter 614. Power converter 614 can selectably convert the USB power to AC power appropriate for either small inductive coil 222 or large inductive coil 224. For instance, power converter 614 can include one or more boost circuits and an inverter. Power converter 614 can deliver the AC power to the puck via AC power lines 620, which can be included in cable 108. (Power converter 614 is sometimes referred to as a “shared” power converter because it provides the operating power for both the small and large coils, though not at the same time.) Main controller 612 can be, e.g., a microcontroller, and can operate to exchange USB data signals with USB adapter interface 618 and to exchange data signals with the puck via one or more data lines 622, e.g., using I²C or other point-to-point communication protocols. Data lines 622 can also be included in cable 108. In addition, although not expressly shown, cable 108 can include DC power line(s) to provide operating power (e.g., DC power received via USB adapter interface 618) for logic circuitry located in puck 630.

Puck circuitry 630 can include a control interface circuit 632, a switch 634, a small coil terminal circuit 636, and a large coil terminal circuit 638. Small coil terminal circuit 636 can be electrically connected to the ends of small inductive coil 222, and large coil terminal circuit 638 can be electrically connected to the ends of large inductive coil 638. Switch 634 can operate responsive to control signals from control interface circuit 632 to selectably deliver AC power from AC power lines 620 to either small coil terminal circuit 636 or large coil terminal circuit 638. In some embodiments, switch 634 (or each of small coil terminal circuit 636 and large coil terminal circuit 638) can also include circuitry to detect modulation of the AC power and/or to add modulation to the AC power, enabling data communication with a compatible wireless power receiver device.

Control interface circuit 632 can be, e.g., a microcontroller, FPGA, or the like. Control interface circuit 632 can be coupled to main controller 612 via data lines 622 and to switch 634 (and optionally to each of small coil terminal circuit 636 and large coil terminal circuit 638). Control interface circuit 632 can communicate with switch 634 to send control instructions to switch 634, e.g., to select the destination for AC power and/or to instruct switch 634 (or either of small coil terminal circuit 636 or large coil terminal circuit 638) to modulate the AC power to communicate with a device being charged. In some embodiments, control interface circuit 632 can also receive data from switch 634 (or from small coil terminal circuit 636 and large coil terminal circuit 638). For instance, switch 634 (or small coil terminal circuit 636 or large coil terminal circuit 638) may send data indicative of detected modulations in the AC power to control interface circuit 632. In various embodiments, control interface circuit 632 can interpret the data to determine any action to be taken and communicate instructions to switch 634 (or to small coil terminal circuit 636 and/or large coil terminal circuit 638) and/or main controller 612. Additionally or instead, control interface circuit 632 can forward data received from switch 634 (or from small coil terminal circuit 636 and/or large coil terminal circuit 638) to main controller 612, and main controller 612 can interpret the data, determine actions, and communicate instructions to control interface circuit 632 and/or shared power converter 614.

For example, when no device is present, main controller 612 can alternately direct AC current for low power pings from shared power converter 614 to small coil terminal circuit 636 or large coil terminal circuit 638. Switch 634 (or the relevant one of small coil terminal circuit 636 or large coil terminal circuit 638) can provide data indicative of detected modulation (or absence thereof). Based on the data, main controller 612 (or control interface circuit 632) can determine whether a receiver device is present and whether a receiver device that is present is S-type or L-type. Once a device of a particular type is detected, main controller 632 can direct shared power converter 614 to produce AC current of the appropriate frequency and amplitude for charging a device of the detected device type. Via control interface circuit 632, main controller 632 can instruct switch 634 to deliver the AC current to either small coil terminal circuit 636 or large coil terminal circuit 638, depending on the type of device that was detected. Current delivery can be adjusted or ended based on feedback from the device being charged, which can be communicated using current modulation (e.g., in accordance with Qi or other wireless charging protocols) detected by switch 634 (or by small coil terminal circuit 636 or large coil terminal circuit 638).

It should be understood that control and driver circuitry 600 is illustrative and that variations and modifications are possible. In the example shown, power conversion is performed externally to the puck (or main body of wireless charger device 100), which can improve thermal performance; however, if desired, power conversion circuitry can be included in the puck. Separate power converters for the small and large inductive coils can be used, and the power converters can be located in different places (e.g., one in the boot and one in the puck); however, as long as both inductive coils are not operated at the same time, using a single shared power converter can reduce manufacturing cost.

### Example Dual-sided Wireless Charger Devices

In examples described above, a single-sided wireless charger device provides a single charging surface that accommodates both L-type and S-type devices. A single-sided wireless charger device can interoperate with devices of multiple types; however, as described above, only one device at a time can be charged. In other embodiments, a “dual-sided” wireless charger device can provide two opposing charging surfaces, allowing two devices of different types to be charged at the same time.

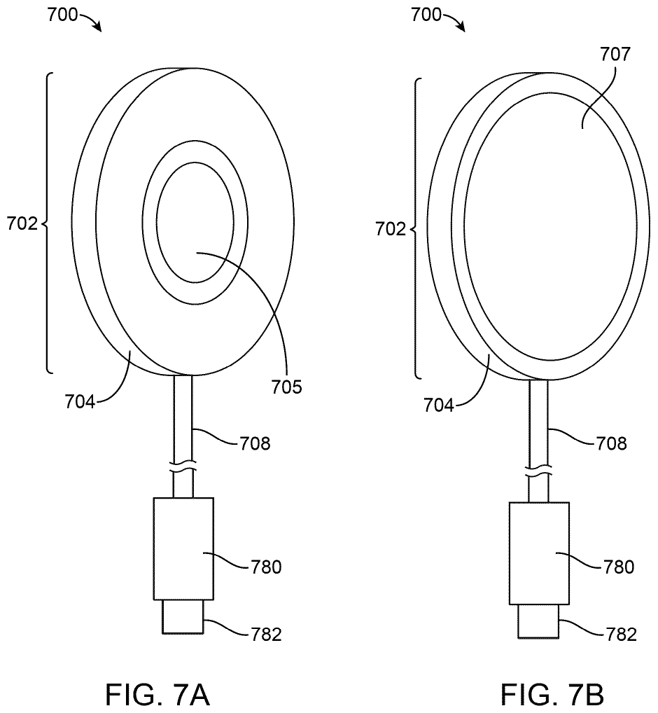

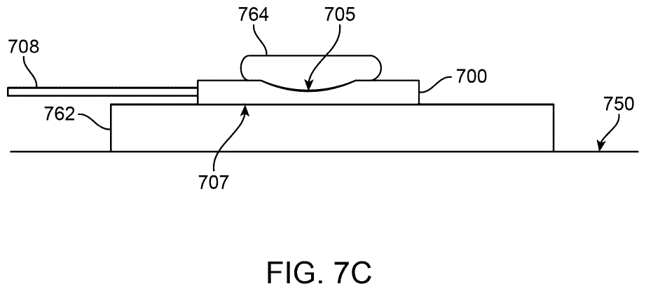

FIGS. 7A and 7B show a rear perspective view and a front perspective view of a dual-sided wireless charger device 700 according to some embodiments. Wireless charger device 700 can include a puck-shaped main body 702 formed from an enclosure 704 having a first surface that holds a small cap 705 and an opposing second surface that holds a large cap 707. For convenience of description, the first surface is referred to herein as a “rear” or “bottom” surface while the second surface is referred to herein as a “front” or “top” surface. A cable 708 can extend from enclosure 704. The distal end of cable 708 (which can be of arbitrary length) can include a connector boot 780 that provides a connector, such as a USB-C plug connector 782, to allow cable 708 to be connected to an external power source (e.g., wall power via a USB-compatible power adapter capable of receiving USB-C plug connector 782). Enclosure 704 can be made of aluminum, other electrically conductive materials, or a plastic material with a conductive insert and can hold a large inductive transmitter coil (compatible with a first, or L-type, wireless charging specification) and a small inductive transmitter coil (compatible with a second, or S-type, wireless charging specification). The large and small inductive transmitter coils can be annular coils having respective inner diameters and respective outer diameters, related such that the outer diameter of the large coil is greater than the outer diameter of the small inductive coil. In some embodiments, the inner and outer diameters of the small coil can correspond to a wireless charging specification associated with S-type devices while the inner and outer diameters of the large inductive coil correspond to a (different) wireless charging specification associated with L-type devices. The two inductive coils can be arranged coaxially, with the small inductive coil oriented to direct magnetic flux toward small cap 705 and the large inductive coil oriented to direct magnetic flux toward large cap 707.

Small cap 705 and large cap 707 can each be made of polycarbonate or other plastic and coated on the exposed side with soft-touch silicone or the like to provide a durable surface. Other materials that are permeable to electromagnetic fields can also be used. In some embodiments, the exposed surfaces of small cap 705 and large cap 707 can be low-friction surfaces (e.g., textured silicone), as wireless charger device 700 can rely on magnetic forces rather than friction for maintaining alignment with a device to be charged. In some embodiments, small cap 705 can provide a concave surface (e.g., for charging a wearable device that has a convex charging surface) while large cap 707 can provide a flat surface (e.g., for charging a portable device that has a flat charging surface). In some embodiments, the diameters of small cap 705 and large cap 707 are chosen based on the outer diameters of the small and large inductive coils; for instance, large cap 707 can have a diameter that extends across most of the surface of enclosure 704 while small cap 705 can have a smaller diameter, large enough to allow the small inductive coil to operate efficiently.

In operation, an S-type device to be charged can be placed in contact with small cap 705. At the same time or at a different time, an L-type device to be charged can be placed in contact with large cap 707. For example, FIG. 7C shows a simplified side view of a stacked arrangement for concurrent wireless charging of an L-type device 762 and an S-type device 764 according to some embodiments. For example, L-type device 762 can be a smart phone that has a wireless power receiver coil oriented toward its back side, and S-type device 764 can be a smart watch that has a wireless power receiver coil oriented toward its back side. For simultaneous charging of both devices, L-type device 762 can be placed on a surface 750 (e.g., a table top) so that its receiver coil is oriented upward (e.g., a phone can be placed face down). Wireless charger device 700 can be placed on top of L-type device 762 with large cap 707 oriented toward the top surface of L-type device 762. S-type device 764 is placed on top of wireless charger device 700 with small cap 705 oriented toward the back side of S-type device 764. As described below, control logic in wireless charger device 700 can determine that both devices are present and can simultaneously operate the small and large inductive coils to provide power to both devices. In some embodiments, the control logic may prioritize charging one type of device over the other type, e.g., to avoid overheating. Further, it should be understood that simultaneous presence of two receiver devices is not required; at any given time, wireless charger device 700 can charge either an L-type or S-type device (or both concurrently) depending on what devices are detected.

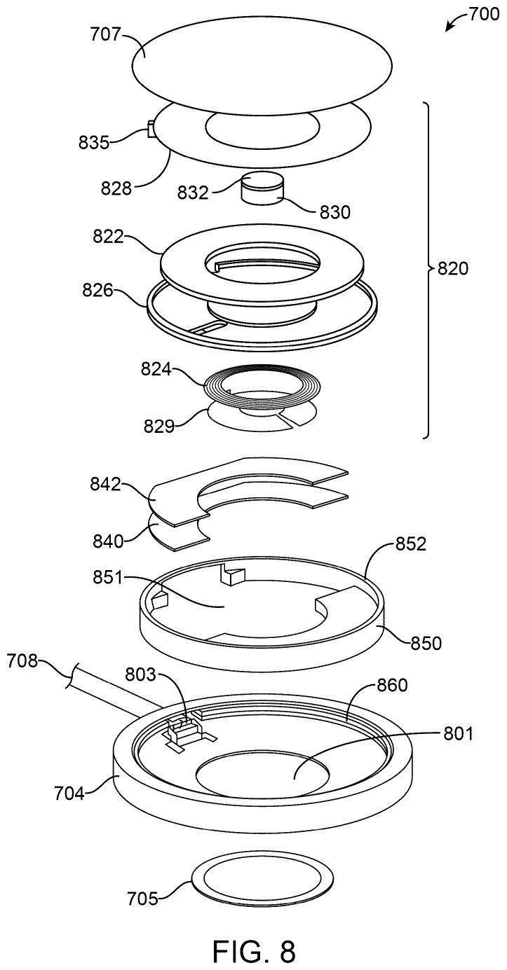

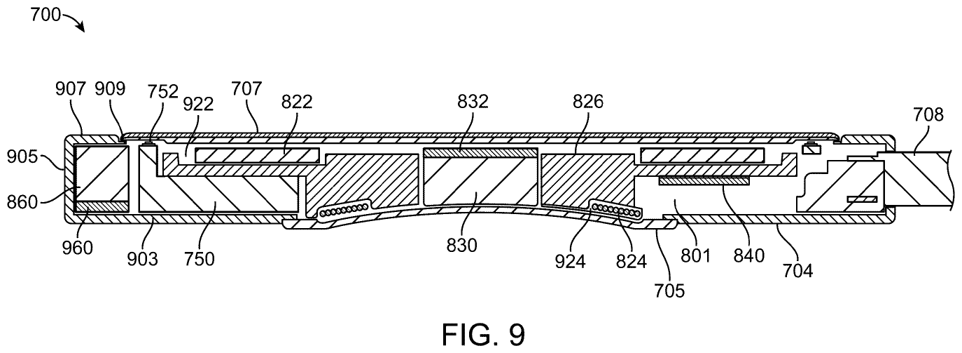

FIG. 8 shows a simplified exploded view of wireless charger device 700 according to some embodiments, and FIG. 9 shows a simplified side cross-section view of wireless charger device 700 according to some embodiments. As described above, wireless charger device 700 can have a puck-shaped main body defined by an enclosure 704 that has a small cap 705 on one surface (referred to for convenience as the “bottom” or “rear” surface) and a large cap 707 on the opposing surface (referred to for convenience as the “top” or “front” surface). Both of small cap 705 and large cap 707 can be made of soft-touch silicone or other materials as described above. Small cap 705 can have a concave central region, as best seen in FIG. 9.

Enclosure 704 can be made of aluminum, other electrically conductive materials, or a plastic material. As best seen in FIG. 9, enclosure 704 can be formed as a monolithic structure that includes a bottom wall 903, a sidewall 905, and an overhanging lip 907 at the top surface of wireless charger device 700. Bottom wall 903 can have an central annular opening 801 to accommodate small cap 705. In some embodiments, lip 907 can be sloped (e.g., at an angle of around 5 or 10 degrees) so that its inner edge is higher than its outer edge. A recessed ledge 909 can extend radially inward from lip 907 to receive large cap 707. An annular magnetic alignment component 860 for use in aligning L-type devices can be positioned adjacent to sidewall 905 of enclosure 704, extending between bottom wall 903 and lip 907. Annular magnetic alignment component 860 can be formed of arcuate magnets (e.g., sintered rare-earth magnets) that are magnetized into a “quad-pole” configuration in which an inner arcuate region of each magnet has an axial magnetization in a first direction, an outer arcuate region of each magnet has an axial magnetization in a second direction opposite the first direction, and a central arcuate region of each magnet is non-magnetized. A DC magnetic shield 960 can be placed beneath annular magnetic alignment component 860. Annular magnetic alignment component 860 can direct magnetic flux through lip 907, providing a magnetic force to align a compatible device to the top surface of wireless charger device 700. In some embodiments, L-type devices can conform to MPP specifications, and annular magnetic alignment component 860 can conform to these specifications.

As shown in FIG. 8, a charging coil assembly 820 can include a large inductive coil 822, a small inductive coil 824, a ferrite 826, e-shields 828, 829, and a central magnet 830. Each of large inductive coil 822 and small inductive coil 824 can be a coil of wound copper wire. Large inductive coil 822 and small inductive coil 824 can be arranged coaxially along a z-axis. As best seen in FIG. 9, large inductive coil 822 can be a flat planar coil, while small inductive coil 824 can be contoured to approximate the concave shape of small cap 705. Ferrite 826 can be made of ferrimagnetic material (e.g., MnZn). In some embodiments, ferrite 826 can be made of a single integral piece of the ferrimagnetic material that is shaped to serve as a flux guide for both large inductive coil 822 and small inductive coil 824. For instance, as shown in FIG. 9, ferrite 826 can have an outer annular recess region 922 on the top surface to accommodate large inductive coil 822 and an inner annular recess region 924 on the bottom surface to accommodate small inductive coil 824. Since large inductive coil 822 and small inductive 824 are on opposite sides of ferrite 826, the inner diameter of large inductive coil 822 can be either smaller or larger than the outer diameter of small inductive coil 824, as desired. As shown, the portion of ferrite 826 below outer annular recess region 922 can be shaped to provide an area for main logic board 240 that is shielded from AC electromagnetic fields generated by large inductive coil 822 or small inductive coil 824. Although not shown in detail, ferrite 826 can also include slits or grooves to accommodate electrical connections between main logic board 840 and large inductive coil 822 and small inductive coil 824.

Ferrite 826 can also have a central opening 930 (shown in FIG. 9) to accommodate a central alignment magnet 830 for use with S-type devices. Central alignment magnet 830 can be a permanent magnet (e.g., sintered rare-earth magnet) having magnetic polarization along the z-axis. A DC magnetic shield 832 can be placed on top of center alignment magnet 830. In some embodiments, central alignment magnet 830 can be used to align an S-type device that is to be charged using small inductive coil 224. In various embodiments, central alignment magnet 830 can be a dipole magnet or a multi-pole magnet (e.g., as described above with reference to FIGS. 5A and 5B). In the dual-sided arrangement shown in FIGS. 8 and 9, DC magnetic shield 832 can help to prevent DC flux from entering an L-type receiver device positioned on the top surface of wireless charger device 700.

As shown in FIG. 8, a large e-shield 828 can be positioned over the top surface of large inductive coil 822, and a small e-shield 829 can be positioned below the bottom surface of small inductive coil 824. Large e-shield 828 and small e-shield 829 can each be made of a flexible printed circuit board printed with a pattern of conductive material to block electric fields while being permeable to magnetic fields. The pattern of conductive material can be disposed on the top surface of large e-shield 828 and the bottom surface of small e-shield 829 (i.e., the surface oriented away from the inductive coil in each instance). The patterns can be designed to block AC electric fields while being transparent to (or having negligible effect on) AC magnetic fields. As in the single-sided example described above, the patterns of conductive material in e-shields 828, 829 can be similar or different from each other. For instance, small e-shield 829 can include radial conductive traces in a spoke-like pattern while large e-shield 828 can include arcuate conductive traces. As long as no trace forms a circle, eddy currents in e-shields 829, 829 can be avoided. Large e-shield 828 can include one or more peripheral grounding tabs 835, which can extend around ferrite 826. Grounding tab 835 can be an extension of the flexible printed circuit board with one or more conductive traces printed thereon. The bottom surface of ferrite 826 can be partially coated or covered with a conductive material to provide grounding, and grounding tab 835 can be electrically connected to the conductive material. E-shield 829 can also be grounded to the bottom surface of ferrite 826 using one or more grounding tabs.

A support frame 850 can be positioned between annular magnetic alignment component 860 and charging coil assembly 820, to provide space to accommodate main logic board 840. Support frame 850 can be a frame made of glass-reinforced polycarbonate or other plastics or the like and can have a raised outer periphery that extends toward large cap 707. The center portion of support frame 850 can include an opening 851 to accommodate main logic board 840 without adding to the overall height of wireless charger device 700. A near-field communication (NFC) coil 852, which can be, e.g., a planar coil of three, four, or five turns, can be placed on top of the raised outer periphery of support frame 850 and held in place using PSA. As shown in FIG. 9, NFC coil 852 can be inboard of the inner edge of lip 907 and can transmit through large cap 707. Ends of NFC coil 852 can be electrically coupled to main logic board 840, and main logic board 840 can include NFC tag circuitry that can support identification and/or authentication of wireless charger device 700 to a compatible electronic device. In some embodiments, NFC coil 852 may be used with L-type devices that charge via large inductive coil 822 and that incorporate compatible NFC reader circuitry.

Main logic board 840 can be secured to the back surface of ferrite 826 using a PSA 842. Although not shown in detail, main logic board 840 can include contact pads that connect to external wires (e.g., from cable 708) extending through opening 803 of enclosure 704, contact pads that connect to the ends of large inductive coil 822 and small inductive coil 824, and additional ground contacts on the bottom side for grounding enclosure 704. Main logic board 840 can also include circuit components to control operation of large inductive coil 822 and small inductive coil 824. Such components can include, e.g., surface-mounted integrated circuits that are mounted on the bottom side of main logic board 840 and extend into central opening 851 of support frame 850. For example, depending on implementation, main logic board 840 can be coupled to receive DC power from cable 708 and can include circuitry for converting the DC power to AC power to drive large inductive coil 822 and small inductive coil 824. In some embodiments, some or all of the power converter circuitry can be external to the main body formed by enclosure 704. For instance, some or all of the power converter circuitry can be disposed in connector boot 780 at the distal end of cable 708, and main logic board 840 can receive AC power via cable 708. In addition or instead, main logic board 840 can include logic circuits (e.g., a microcontroller, ASIC, FPGA, or the like) to monitor the behavior of large inductive coil 822 and small inductive coil 824 and to control current supplied to large inductive coil 822 and small inductive coil 824 based on the monitoring. Specific examples of control and driver circuitry for wireless charger device 700 are described below. In some embodiments, main logic board 840 can also include NFC tag circuit components coupled to NFC coil 852. In some embodiments, logic circuits, power circuits, and/or NFC tag circuits can be implemented as integrated circuits mounted on main logic board 840, and the integrated circuits may be covered by shield cans to avoid electrical interference.

As shown in FIGS. 8 and 9, cable 708 can enter enclosure 704 via an opening 803 through sidewall 905. Cable 708 can include multiple wires that connect to contacts on the bottom side of main logic board 840. The wires can include AC and/or DC power wires for one or for one or both of large inductive coil 822 and/or small inductive coil 824, as well as signal wires to enable communication between main logic board 840 and circuitry disposed elsewhere in cable 708 (e.g., in cable boot 780).

In operation, an L-type device to be charged (e.g., a portable device) can be placed on the charging surface defined by large cap 707. The L-type device can have an inductive receiver coil compatible with large inductive coil 822. Presence of the L-type device can be determined using low-power pings or the like. For instance, a small AC current can be passed through large inductive coil 822, and a particular change in impedance can be detected when a compatible L-type device is present. When an L-type device is detected responsive to a ping, large inductive coil 822 can be activated to begin charging and/or to communicate with the detected device using modulation of the current (e.g., to receive a request for power, to determine a power level to provide, etc.). Low-power pings and charging operations can conform to Qi specifications or other specifications for wireless power transfer. Likewise, an S-type device to be charged (e.g., a wearable device) can be placed on the charging surface defined by small cap 705. The S-type device can have an inductive receiver coil compatible with small inductive coil 824. Presence of the S-type device can be determined using low-power pings or the like. For instance, a small AC current can be passed through small inductive coil 824, and a particular change in impedance can be detected when a compatible S-type device is present. When an S-type device is detected responsive to a ping, small inductive coil 824 can be activated to begin charging and/or to communicate with the detected device using modulation of the current (e.g., to receive a request for power, to determine a power level to provide, etc.). Low-power pings and charging operations can conform to Qi specifications or other specifications for wireless power transfer. Any specification or combination of specifications can be used, and different specifications can be implemented for charging of L-type and S-type devices.

It should be understood that large inductive coil 822 and small inductive coil 824 can (but need not) operate at different frequencies and/or different levels of power output. It should also be understood that both coils can be operated concurrently if both an L-type device and an S-type device happen to be present concurrently. In some embodiments, when two receiver devices are concurrently present, power delivered to one or both devices may be reduced (by reducing the current in one or the other coil) in accordance with prioritization logic in wireless charger device 700.

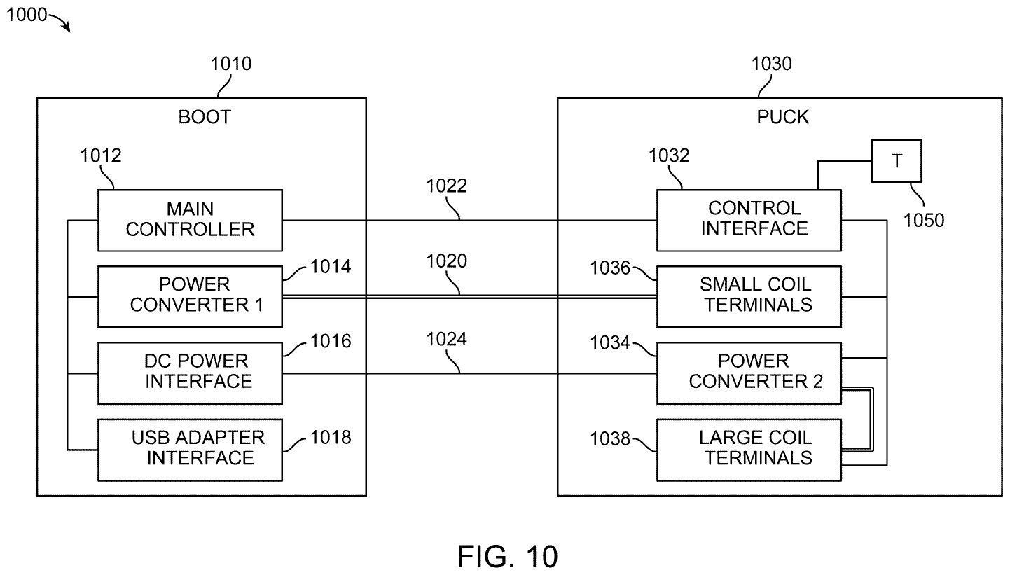

In some embodiments, control and driver circuitry for the two inductive coils can be at least partially shared to reduce costs. FIG. 10 shows a simplified schematic diagram of control and driver circuitry 1000 for a wireless charger device according to some embodiments. Control and driver circuitry 1000 can be implemented in wireless charger device 700 or similar devices where two different inductive coils can operate individually or concurrently. Control and driver circuitry 1000 can include boot circuitry 1010 and puck circuitry 1030. In some embodiments, boot circuitry 1010 can be included in a boot (e.g., connector boot 780) or other structure external to the puck-shaped housing of wireless charger device 700, while puck circuitry 1030 can be included within the puck-shaped housing, e.g., using components on main logic board 840 described above.

Boot circuitry 1010 can include a USB adapter interface 1018, a main controller 1012, a first power converter 1014, and a DC power interface 1016. USB adapter interface 1018 can include a standard USB connector (e.g., USB-C plug connector 782 shown in FIGS. 7A and 7B) that can provide USB power and data signal paths. USB adapter interface 1018 can provide the USB power (which is DC power) to first power converter 1014 and to DC power interface 1016. First power converter 1014 can convert the USB power to AC power appropriate for small inductive coil 824. For instance, first power converter 1014 can include a boost circuit and an inverter. First power converter 1014 can deliver the AC power to the puck via AC power lines 1020, which can be included in cable 708. DC power interface 1016 can deliver the DC power to the puck via DC power line(s) 1024, which can also be included in cable 708. In various embodiments, DC power interface 1016 can simply pass through USB power to DC power lines 1024; if desired, DC power interface 1016 can include circuitry to convert USB power to another type of DC power (e.g., a different voltage or current level) and pass the converted power to data lines 1024. Main controller 1012 can be, e.g., a microcontroller, and can operate to exchange USB data signals with USB adapter interface 1018 and to exchange data signals with the puck via one or more data lines 1022, e.g., using I²C or other point-to-point communication protocols. Data lines 1022 can also be included in cable 708.

Puck circuitry 1030 can include a control interface circuit 1032, a second power converter 1034, a small coil terminal circuit 1036, and a large coil terminal circuit 1038. Small coil terminal circuit 1036 can receive AC power via AC power lines 1022 and can be electrically connected to the ends of small inductive coil 824; in this manner, AC power can be provided to small inductive coil 824. Large coil terminal circuit 1038 can be electrically connected to the ends of large inductive coil 822. Second power converter 1034 can receive DC power via DC power line(s) 1024 and convert the received DC power to AC power appropriate for large inductive coil 822 and can deliver the AC power to large coil terminal circuit 1038; in this manner, AC power can be provided to large inductive coil 822. Providing separate power converters 1014, 1034 allows small inductive coil 824 and large inductive coil 822 to operate concurrently at different frequencies and/or amplitudes. In some embodiments, puck circuity 1030 can also include circuitry (e.g., in small coil terminal circuit 1036 and large coil terminal circuit 1038) to detect modulation of the AC power on large inductive coil 822 or small inductive coil 824 and/or to add modulation to the AC power, enabling data communication with a compatible wireless power receiver device.

Control interface circuit 1032 can be, e.g., a microcontroller, FPGA, or the like. Control interface circuit 1032 can be coupled to main controller 1012 via data lines 1022, to small coil terminal circuit 1036, to second power converter 1034, and to large coil terminal circuit 1038. Similarly to control interface circuit 632, control interface circuit 1032 can provide control instructions to enable or disable power delivery to large inductive coil 822 and/or small inductive coil 824 and/or to modulate the AC power to communicate with a device being charged. In some embodiments, control interface circuit 1032 can also receive data from small coil terminal circuit 1036 and/or large coil terminal circuit 1038. For instance, small coil terminal circuit 1036 and/or large coil terminal circuit 1038 may send data indicative of detected modulations in the AC power to control interface circuit 1032. In various embodiments, control interface circuit 1032 can interpret the data to determine any action to be taken and communicate instructions to other device components. Additionally or instead, control interface circuit 1032 can forward received data to main controller 1012, and main controller 1012 can interpret the data, determine actions, and communicate instructions to control interface circuit 1032, first power converter 1014, and/or DC power interface 1016.

For example, when no L-type device is present, main controller 1012 can instruct second power converter 1034 (via control interface 1032) to perform a low-power ping in large inductive coil 822. Large coil terminal circuit 1038 can provide data indicative of detected modulation (or absence thereof) to control interface circuit 1032. Based on the signals from large coil terminal circuit 1038, main controller 1012 (or control interface circuit 1032) can determine whether an L-type receiver device is present. Once an L-type receiver device is detected, main controller 1032 can instruct DC power adapter 1024 and second power converter 1034 (via control interface circuit 1032) to produce AC current of the appropriate frequency and amplitude for operating large inductive coil 822 to charge the L-type receiver device. Current delivery can be adjusted or ended based on feedback from the device being charged, which can be communicated using current modulation (e.g., in accordance with Qi specifications or other wireless charging specifications) detected by large coil terminal circuit 1038. Similarly, when no S-type device is present, main controller 1012 can instruct first power converter 1020 to perform a low-power ping in small inductive coil 824. Small coil terminal circuit 1036 can provide data indicative of detected modulation (or absence thereof) to control interface circuit 1032. Based on the signals from small coil terminal circuit 1036, main controller 1012 (or control interface circuit 1032) can determine whether an S-type receiver device is present. Once an S-type receiver device is detected, main controller 1032 can direct first power converter 1020 to produce AC current of the appropriate frequency and amplitude for operating small inductive coil 824 to charge the S-type receiver device. Current delivery can be adjusted or ended based on feedback from the device being charged, which can be communicated using current modulation (e.g., in accordance with Qi specifications or other wireless charging specifications) detected by small coil terminal circuit 1036.

It should be noted that device detection and charging operations for L-type devices and S-type devices can be conducted largely independently of each other. For instance, low-power ping with the large inductive coil can be performed regardless of whether an S-type device is present or being charged by the small inductive coil, and low-power ping with the small inductive coil can be performed regardless of whether an L-type device is present or being charged by the large inductive coil. When devices of both types are concurrently present, prioritization logic may be used to determine how much power can be provided to each device. In some instances, one coil or the other may be shut down to allow the other device to charge more rapidly.

For instance, the arrangement in FIG. 10 shows the power converter for the small inductive coil located in the cable boot while the power converter for the large inductive coil is located in the puck. In this arrangement, it may be desirable (e.g., for thermal management reasons) to deprioritize the large inductive coil when devices of both types are present. Accordingly, when devices of both types are present, main controller 1012 may instruct other components to reduce the AC current to the large coil. In some embodiments, active feedback can be used. For instance, a temperature sensor 1050 in the puck can monitor temperature and provide temperature data to main controller 1012 via control interface circuit 1032. Main controller 1012 can dynamically reduce the current to the large coil (e.g., all the way to zero) to prevent the temperature at sensor 1050 from exceeding a preset upper limit. In this example, the large inductive coil (rather than the small inductive coil) has its current reduced because the power conversion circuitry generates more heat than the other components of control and driver circuitry 1000, and the power conversion circuitry for the large inductive coil is located in the puck. In some embodiments, temperature monitoring can also be performed in the boot, and current to the small inductive coil can be dynamically reduced if excess heat in the boot is detected.

Other arrangements and prioritization algorithms can also be used. For example, the power converter for the large inductive coil can be located in the cable boot while the power converter for the small inductive coil is located in the puck. In this arrangement, the small inductive coil can be deprioritized when devices of both types are present, e.g., based on active feedback, to control the temperature at the puck. As another example, both power converters can be placed in the cable boot (or in the puck); in either case, one or the other inductive coil can be deprioritized to avoid generating excessive heat when devices of both types are present.

### Additional Embodiments

While the invention has been described with reference to specific embodiments, those skilled in the art will appreciate that variations and modifications are possible. For instance, the terms “L-type” and “S-type” are used here in to distinguish two different wireless charging specifications. In general, a wireless charging specification may specify charging coil geometry (e.g., outer and/or inner diameter), operating parameters (e.g., amplitude and frequency of current in the transmitter coil, power transfer rates), associated communication protocols (e.g., using modulation of the AC charging current), and so on. It should be understood that “L-type” and “S-type” can refer to any combination of two different specifications. For example, L-type devices may conform to MPP or another Qi standard, while S-type devices may conform to a proprietary specification for small wearable devices (e.g., the specifications used in a particular line of smartwatches), to a Qi standard, or to a standard other than Qi. Other combinations of specifications can also be used. Where the L-type and S-type specifications provide different coil geometries, having two different coils in the same wireless charger device can extend the range of devices that can be charged using a single wireless charger device. Accordingly, the number of wireless charger devices that a user needs can be reduced.

While embodiments described above include magnetic alignment components for both L-type and S-type devices, it is not required that device(s) being charged have complementary components. Further, some embodiments can omit either or both of the magnetic alignment components, depending on the particular wireless charging specifications being implemented.

A variety of different implementations of control and driver circuitry can be incorporated into wireless charger devices of the kind described herein, and components of such circuitry can be distributed between locations within the main housing of the wireless charger device and external locations (e.g., the cable boot or the like) as desired, not limited to specific examples described above. Further, while embodiments described above support the two wireless charging specifications using at least some shared components, sharing of components is not required. Where implemented, sharing of components can help to reduce manufacturing costs. The control and driver circuitry can obtain power from a variety of external sources using a variety of power systems and converters. While USB is used as an example above, those skilled in the art will appreciate that other options can be substituted.

The size and shape of the wireless charger device can be varied as desired. In some embodiments, a puck-shaped housing having the coils arranged coaxially provides a compact form factor; however the form factor can be modified to accommodate other coil geometries. In various embodiments, the coils can be arranged coaxially and oriented to deliver power through the same charging surface or through opposing charging surfaces. In the latter case, concurrent charging of two devices may be supported.

In various embodiments, a wireless charger device can charge one device at a time (e.g., single-sided wireless charger device 100) or up to two devices at a time (e.g., dual-sided wireless charger device 700). In either case, the number of wireless charger devices users may need to support all of their devices may be reduced, with a dual-sided wireless charger device providing the ability to charge multiple devices at once.

While various circuits and components are described herein with reference to particular blocks, it is to be understood that these blocks are defined for convenience of description and are not intended to imply a particular physical arrangement of component parts. The blocks need not correspond to physically distinct components, and the same physical components can be used to implement aspects of multiple blocks. Components described as dedicated or fixed-function circuits can be configured to perform operations by providing a suitable arrangement of circuit components (e.g., logic gates, registers, switches, etc.); automated design tools can be used to generate appropriate arrangements of circuit components implementing operations described herein. Components described as processors or microprocessors or microcontrollers can be configured to perform operations described herein by providing suitable program code. Various blocks might or might not be reconfigurable depending on how the initial configuration is obtained. Embodiments of the present invention can be realized in a variety of apparatus including electronic devices implemented using a combination of circuitry and software or firmware.

All numerical values and ranges provided herein are illustrative and may be modified. Unless otherwise indicated, drawings should be understood as schematic and not to scale.

Terms such as “top” and “bottom” or “front” and “back” are used for convenience of description and are not intended to imply that any particular spatial orientation of any device is required.

Accordingly, although the invention has been described with respect to specific embodiments, it will be appreciated that the invention is intended to cover all modifications and equivalents within the scope of the following claims.

What is claimed is:

1. A wireless charger device comprising:
a housing having a charging surface that extends in a lateral direction;
a first inductive coil disposed within the housing and having an axis orthogonal to the lateral direction, the first inductive coil having an inner diameter and an outer diameter;
a second inductive coil disposed within the housing and coaxial with the first inductive coil, the second inductive coil having an inner diameter and an outer diameter, wherein the outer diameter of the second inductive coil is smaller than the outer diameter of the first inductive coil;
a ferrite disposed around one lateral side of the first inductive coil and one lateral side of the second inductive coil;
a center magnetic alignment component disposed within the housing and within the inner diameter of the second inductive coil;
an annular magnetic alignment component disposed within the housing and outside the outer diameter of the first inductive coil; and
control and driver circuitry configured to selectably drive a time-varying current in one or both of the first inductive coil and the second inductive coil.

2. The wireless charger device of claim 1 wherein the control and driver circuitry is further configured to drive a first time-varying current in the first inductive coil when a wireless power receiver device of a first type is detected and to drive a second time-varying current in the second inductive coil when a wireless power receiver device of a second type is detected.

3. The wireless charger device of claim 2 wherein the first time-varying current is an alternating current having a first frequency and the second time-varying current is an alternating current having a second frequency that is different from the first frequency.

4. A wireless charger device comprising:
a housing having a charging surface on a first side;
a first inductive coil disposed within the housing and having an axis orthogonal to the charging surface, the first inductive coil having an inner diameter and an outer diameter;
a second inductive coil disposed within the housing and coaxial with the first inductive coil, the second inductive coil having an inner diameter and an outer diameter, wherein the outer diameter of the second inductive coil is smaller than the inner diameter of the first inductive coil;
a ferrite disposed around a back side of the first inductive coil and the second inductive coil such that the ferrite directs magnetic flux from the first inductive coil and the second inductive coil toward the charging surface;
a central alignment magnet disposed within the housing and within the inner diameter of the second inductive coil;
an annular magnetic alignment component disposed within the housing and outside the outer diameter of the first inductive coil; and
control and driver circuitry configured to selectably drive a time-varying current in one or the other of the first inductive coil and the second inductive coil.

5. The wireless charger device of claim 4 wherein the control and driver circuitry is further configured to drive a first time-varying current in the first inductive coil when a wireless power receiver device of a first type is detected proximate to the charging surface and to drive a second time-varying current in the second inductive coil when a wireless power receiver device of a second type is detected proximate to the charging surface.

6. The wireless charger device of claim 5 wherein the first time-varying current is an alternating current having a first frequency and the second time-varying current is an alternating current having a second frequency that is different from the first frequency.

7. The wireless charger device of claim 4 wherein the central alignment magnet is movable along the axis between an active position adjacent to the charging surface and an inactive position retracted from the charging surface.

8. The wireless charger device of claim 7 wherein the central alignment magnet is biased toward the inactive position.

9. The wireless charger device of claim 4 further comprising:
an electric shield disposed between the first and second inductive coils and the charging surface, wherein the electric shield blocks time-varying electric fields and is transparent to time-varying magnetic fields.

10. The wireless charger device of claim 9 wherein the electric shield has an inner annular section sized to match the first inductive coil and an outer annular section sized to match the second inductive coil, the inner annular section and the outer annular section having a gap therebetween.

11. The wireless charger device of claim 4 wherein the control and driver circuitry includes:
a shared power converter circuit configured to selectably produce a first time-varying current for the first inductive coil or a second time-varying current for the second inductive coil;
a switch coupled to selectably transmit current from the shared power converter circuit to terminals of one or the other of the first inductive coil and the second inductive coil; and
control circuitry to control the shared power converter circuit and the switch such that when the shared power converter circuit is producing the first time-varying current, the switch transmits the first time-varying current to the first inductive coil and when the shared power converter circuit is producing the second time-varying current, the switch transmits the second time-varying current to the second inductive coil.

12. The wireless charger device of claim 11 further comprising:
a cable having a first end connected through the housing and a second end; and
a boot connected to the second end of the cable,
wherein the shared power converter circuit is disposed in the boot.

13. A wireless charger device comprising:
a housing having a first charging surface that extends in a lateral direction and a second charging surface opposite the first charging surface;
a first inductive coil disposed within the housing and having an axis orthogonal to the lateral direction, the first inductive coil having an inner diameter and an outer diameter;
a second inductive coil disposed within the housing and coaxial with the first inductive coil, the second inductive coil having an inner diameter and an outer diameter, wherein the outer diameter of the second inductive coil is larger than the outer diameter of the first inductive coil;
a ferrite disposed between the first inductive coil and the second inductive coil such that the ferrite directs magnetic flux from the first inductive coil toward the first charging surface and directs magnetic flux from the second inductive coil toward the second charging surface;
a central alignment magnet disposed within the housing and within the inner diameter of the second inductive coil, the central alignment magnet oriented to attract a complementary magnet at the first charging surface;
an annular magnetic alignment component disposed within the housing and outside the outer diameter of the first inductive coil, the annular magnetic alignment component oriented to attract a complementary magnetic alignment component at the second charging surface; and
control and driver circuitry configured to selectably drive a time-varying current in one or both of the first inductive coil and the second inductive coil.

14. The wireless charger device of claim 13 wherein the control and driver circuitry is further configured to drive a first time-varying current in the first inductive coil when a wireless power receiver device of a first type is detected and to drive a second time-varying current in the second inductive coil when a wireless power receiver device of a second type is detected.

15. The wireless charger device of claim 14 wherein the control and driver circuitry is further configured to concurrently drive both the first time-varying current in the first inductive coil and the second time-varying current in the second inductive coil when wireless power receiver devices of both the first type and the second type are concurrently detected.

16. The wireless charger device of claim 14 wherein the first time-varying current is an alternating current having a first frequency and the second time-varying current is an alternating current having a second frequency that is different from the first frequency.

17. The wireless charger device of claim 13 further comprising:
a first electric shield disposed between the first inductive coil and the first charging surface; and
a second electric shield disposed between the second inductive coil and the second charging surface,
wherein each of the first and second electric shields blocks time-varying electric fields and is transparent to time-varying magnetic fields.

18. The wireless charger device of claim 13 further comprising:
a cable having a first end connected through the housing and a second end; and
a boot connected to the second end of the cable.

19. The wireless charger device of claim 18 wherein the control and driver circuitry includes:
a first power converter circuit configured to produce a first time-varying current for the first inductive coil; and
a second power converter circuit configured to produce a second time-varying current for the second inductive coil, wherein the first time-varying current and the second time-varying current have different frequencies,
wherein one of the first power converter circuit or the second power converter circuit is disposed within the boot and the other of the first power converter circuit or the second power converter circuit is disposed within the housing.

20. The wireless charger device of claim 19 wherein the control and driver circuitry further includes:
a temperature sensor to monitor a temperature inside the housing; and
a control circuit configured to reduce or increase current from one or both of the first power converter circuit or the second power converter circuit responsive to changes in the temperature inside the housing, wherein the control circuit prioritizes current for the one of the first power converter circuit or the second power converter circuit that is disposed within the boot.
